(19) United States
(12) Patent Application Publication
(10) Pub. No.: US 2004/0179097 A1
(43) Pub. Date: Sep. 16, 2004

(54) Robust layered 3:2 pulldown film mode source detection

(76) Inventors: Chao-Chee Ku, Hsin-Chu (TW); Kuan Liang, Hsin-Chu (TW)

Correspondence Address: ANTHONY R BARKUME, 20 GATEWAY LANE, MANORVILLE, NY, 11949, US

(21) Appl. No.: 10/796,849

(22) Filed: Mar. 8, 2004

(30) Foreign Application Priority Data
Mar. 13, 2003 (TW) 09210553

(51) Int. Cl. H04N 5/253

(52) U.S. Cl. 348/96

(57) ABSTRACT

A robust layered 3:2 pulldown film mode source detection method is proposed. The method provides video signals of three fields, a current field, a last field and a next field. The video signals are used to determine a film source. The method comprises steps of: define a plurality of layers and each layer has a threshold and a counter; compare each difference between pixels of the last field and the next field with each layer's threshold to obtain a comparing result; according to said comparing result, determine a change of said counter of each layer; and determine a result sequence by said counter to decide said film mode source.

### FIELD OF THE INVENTION

The present invention is related to a method for robust layered 3:2 pulldown film mode source detection, and more particularly to determine a sequence by using the counters of plural number layers and detect if the video source is film mode source. It is applicable to the detection of Mixed Film mode Source and Interlaced Video Source.

### BACKGROUND OF THE INVENTION

Generally, a film is made by 24 frames/sec, but the NTSC (60 Hz) TV is played at 60 fields per second, so it isn't able to play Film Source directly at the 60 Hz field rate TV. It is necessary to pre-process on the film sources and adjust the field rate so that the film sources can be played at 60 Hz TV. The film source is as shown in the upper portion of FIG. 1, and then 3:2 pulldown methods is used to convert 24 FPS film source into 60 field/sec source as shown in the bottom portion of FIG. 1, so that, the NTSC TV can play smoothly and without producing flicker due to the low field rate.

As the popularization of the Flat Panel Display (FPD), the received video sources of an FPD display controller may be film source or interlaced video source (such as TV signals). The film itself has complete frames originally with 24 frames/sec. frame rate, but it is converted into 60 Fields/sec by 3:2 pulldown to meet the display rate (60 per/sec). The interlaced video signals have no completely frame, but they have odd and even numbers of fields. Therefore, while de-interlacing, the display controller has to determine whether the signal source is film source or interlaced video source to choose the best de-interlacing method.

In the prior arts, the method to determine a film source or an interlaced video source is done by 3:2 pulldown detection. The basic principle of 3:2 pulldown detection is as shown in FIG. 1. The film source is processed by 3:2 pulldown to get a frame difference with a fixed sequence, that is, 100001000010000, where “1” represents the field difference is small, and “0” represents the field difference is large. Conventionally, the basic procedure of 3:2 pulldown detection is to provide three fields as shown in FIG. 2, and process the following steps as shown in FIG. 3:

Step 101: Input the next field (F2); the current field is F1.

Step 102: Input the last field (F0); the current field is F1.

Step 103: Check the pixel differences, since F0 and F2 have the same polarity, that is, they are all in the odd or even fields in a specific time, so their pixels are located in the same spatial locations but different temporal positions.

Step 104: Sum the total difference of the fields, i.e. sum every absolute value from step 103, and then get the total difference of the F0 and F2 fields.

Step 105: Define the critical pixel difference for the threshold.

Step 106: Compare with the output of step 104 and the threshold of step 105. If the output of step 104 is bigger than the threshold of step 105, the output of step 106 is 1;otherwise, the output is 0.

Step 107: Output result sequences. It may be 0011100011. If the result sequences 000010000, 0100001000, 0010000100, 0001000010 or 0000100001 are met, it is determined to be 3:2 pullldown film source.

There are some drawbacks in the conventional 3:2 pulldown detection. Firstly, the sum of absolute value of frame difference is used to compare with a threshold for the determination is not quite suitable. Because the difference of the image characteristics is huge, so the determination of the threshold is very critical and important. Depending only on a threshold is not a good idea. For example, if in an image, most parts of it are static but with a small fast moving object, when only frame difference is calculated and compared with the threshold. Then, most likely, it will be misjudged and weaving method is used. This will produce motion artifacts.

To avoid this situation, more robust methods have to be used to perform the 3:2 pulldown detection.

### SUMMARY OF THE INVENTION

An objective of the present invention is to provide a method for the robust layered 3:2 pulldown film mode source detection.

Another objective of the present invention is to determine by the counters without usage of the absolute values.

Another objective of the present invention is to lead the layer idea to counter. Each layer has its own threshold to expand its robustness.

Another objective of the present invention is to use the sequence characteristic as the benchmark, so that present invention is applicable to detect the film mode source and Interlaced Video source.

According to the present invention, a robust layered 3:2 pulldown film mode source detection method is proposed. The method provides video signals of three fields, one is the current field, another is the last field of the current field, and the other is the next field to the current field. The video signals are used to determine a film source and the method comprises steps of:

Define a plurality of layers, and every layer has a threshold and a counter.

Compare the differences between pixels of the last field and the next field with each layer's threshold to obtain a comparing result.

According to the comparing result, determine the change of counter of each layer.

Determine a sequence by the counter to decide the film mode source.

In accordance with one aspect of the present invention, the layers are three.

In accordance with one aspect of the present invention, if the absolute value of every difference is bigger than the threshold of a layer, the counter of layer is increased by 1.

In accordance with one aspect of the present invention, the result sequence uses the frame difference of the film source processed by 3:2 pulldown as the fixed sequence by its counter.

The present invention may best be understood through the following description with reference to the accompanying drawings, in which:

### BRIEF DESCRIPTION OF THE DRAWINGS

FIG. 1 shows the conventional flowchart for 3:2 Pull-down detection;

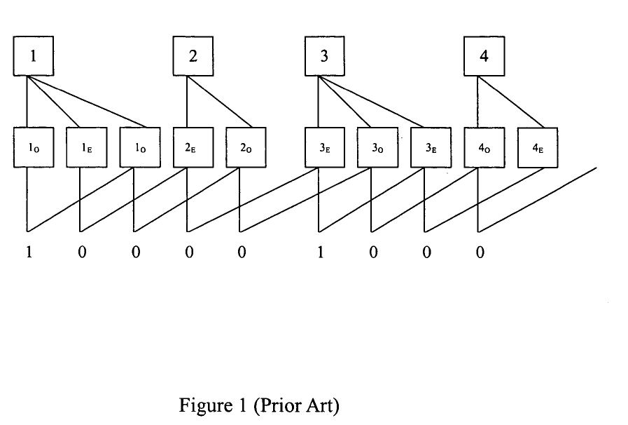

FIG. 2 shows the conventional structure with three fields required for the 3:2 Pull-down detection;

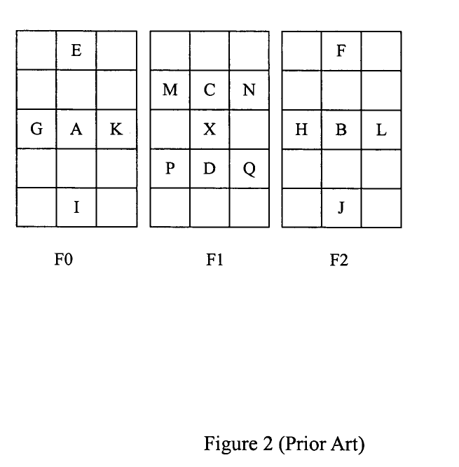

FIG. 3 shows the conventional 3:2 Pull-down detection flowchart;

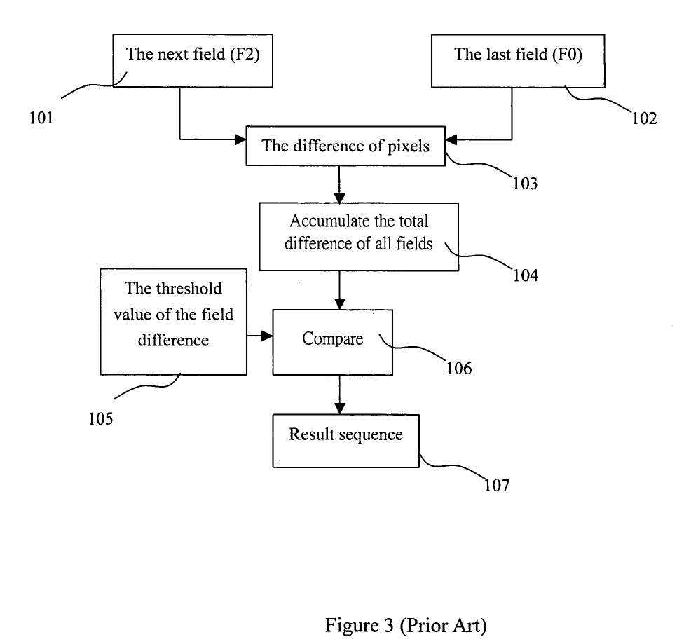

FIG. 4 shows the four fields structure according to the present invention;

FIG. 5 shows a preferred flowchart according to the present invention;

FIG. 6 shows the procedure of step 204;

FIG. 7 shows the procedure of step 205;

FIG. 8 shows the procedure of step 207; and

FIG. 9 shows the procedure of step 201.

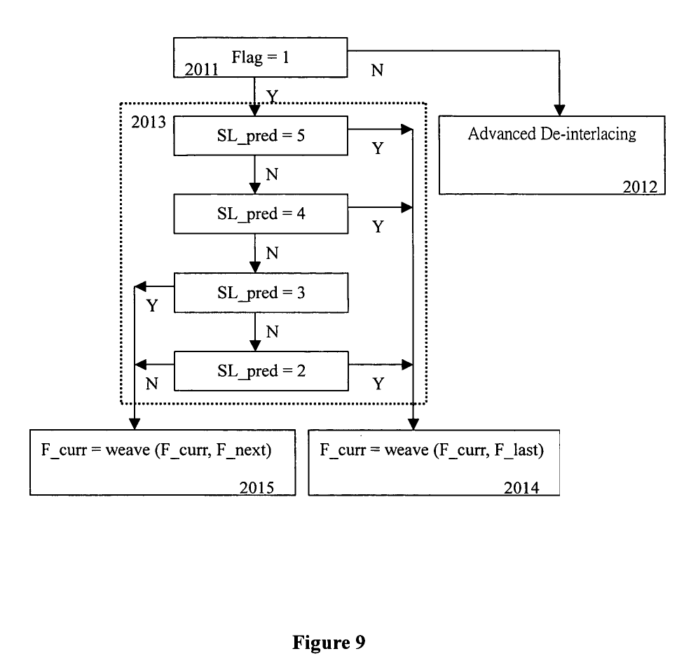

### DETAILED DESCRIPTION OF THE PREFERRED EMBODIMENT

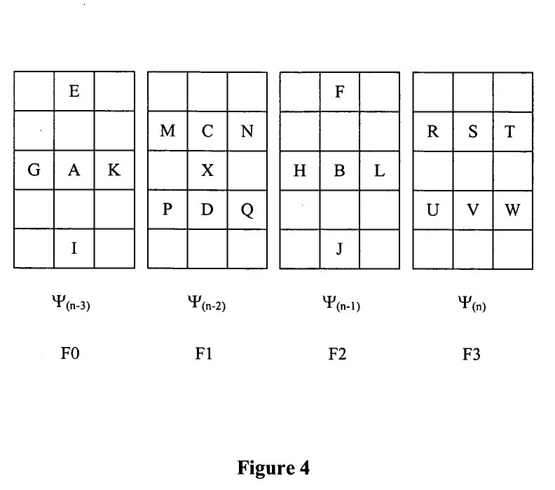

FIG. 4 shows 4 fields structure according to the present invention. The 4 fields, Ψ₍ₙ₋₃₎, Ψ₍ₙ₋₂₎, Ψ₍ₙ₋₁₎ and Ψ₍ₙ₎, are stored in the fame buffer and represents the (n-3), (n-2), (n-1) and (n) fields, respectively. When the 3:2 pulldown detection is processed, Ψ₍ₙ₋₂₎, Ψ₍ₙ₋₁₎ and Ψ₍ₙ₎ are used. While de-interlace is processed, Ψ₍ₙ₋₃₎, Ψ₍ₙ₋₂₎ and Ψ₍ₙ₋₁₎ are used. Such a frame buffer arrangement is used to detect an abnormal sequence or a change of signal source from a film mode source to an interlaced video source, and to avoid the error due to delay situation. For convenience, Ψ₍ₙ₋₃₎, Ψ₍ₙ₋₂₎, Ψ₍ₙ₋₁₎, and Ψ₍ₙ₎ may represent with F0, F1, F2, and F3.

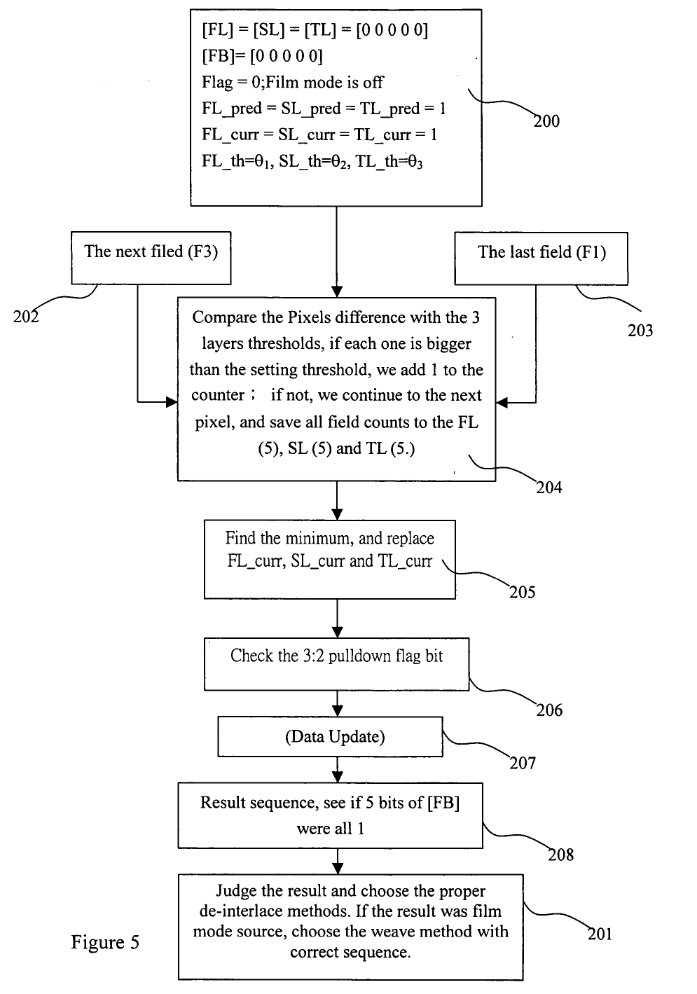

FIG. 5 shows the preferred flowchart of the invention. There are 3 layers used to process detection as the following steps:

Step 200: Some initial value. [FL], [SL], [TL] and [FB] represent the four 1×5 matrixes of the first layer, the second layer, the third layer and the 3:2 pulldown Flag Bits, respectively, and the initial values of all the matrixes are set to zero. Flag indicates the 3:2 pulldown detection status. If the flag is on, i.e., Flag=1, it means that the film mode source is detected; otherwise, the it is not a film mode source. FL_curr, SL_curr and TL_curr represent the current values of the first, the second, and the third layers, respectively, and all of the initial values are 1 (the possible values maybe 1˜5, and 1 is set as the initial value). FL_pred, SL_pred and TL_pred represent the next predict values of the first, the second, the third layers, respectively, and all of the initial values are 1 (the possible value maybe 1˜5, and 1 is set as the initial value).

Step 202 and step 203: F3 and F1 represent the next and the last fields while detecting. (F2 is the current field. )

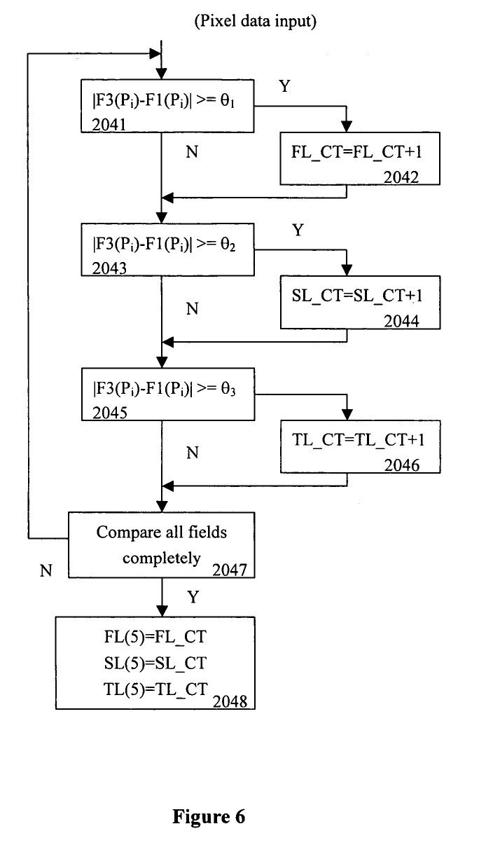

Step 204: Compare the differences of the field pixels with the setting 3 layer thresholds, if each one is bigger than the threshold, each counter will be increased by 1; otherwise process the next pixel. Then the field counters are saved to the FL(5), SL(5) and TL(5). Please refer to FIG. 6, as the following procedures:

Step 2041: Compare the differences of the field pixels with the first layer setting threshold, θ₁.

Step 2042: If the difference of the pixels is bigger than the first layer's threshold, θ₁, then the first layer counter ( FL_CT) is increased by 1; otherwise process the next procedures.

Step 2043: Compare the differences of the field pixels with the second layer setting threshold, θ₂.

Step 2044: If the difference of the pixels is bigger than the second layer's threshold, θ₂, then the second layer counter (SL_CT) is increased by 1; otherwise process the next procedures.

Step 2045: Compare the differences of the field pixels with the third layer setting threshold, θ₃.

Step 2046: If the difference of the pixels is bigger than the third layer's threshold, θ₃, the third layer counter (TL_CT) is increased by 1; otherwise process the next procedures.

Step 2047: Check if the all field had processed completely. If yes, go to step 2048; otherwise continue to input pixels.

Step 2048: Save total field counters of each layer to FL(5), SL(5) and TL(5).

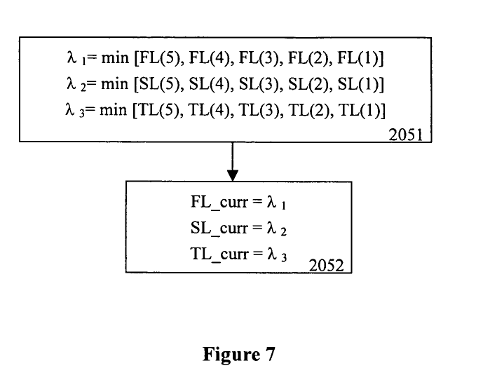

Step 205: Find the minimum value, and replace FL_curr, SL_curr, and TL_curr. Please refer to FIG. 7, as the following procedures:

step 2051: Find the minimum values, λ₁, λ₂ and λ₃, of the matrixes [FL], [SL], and [TL].

Step 2052: Replace FL_curr, SL_curr and TL_curr with λ₁, λ₂, λ₃.

Step 206: Check the 3:2 pulldown flag bit. If (FL_curr=FL_pred) and (SL_curr=SL_pred) and (TL_curr=TL_pred), set the 5^{th} th element of the Flag bit matrix, FB(5)=1; otherwise set it 0.

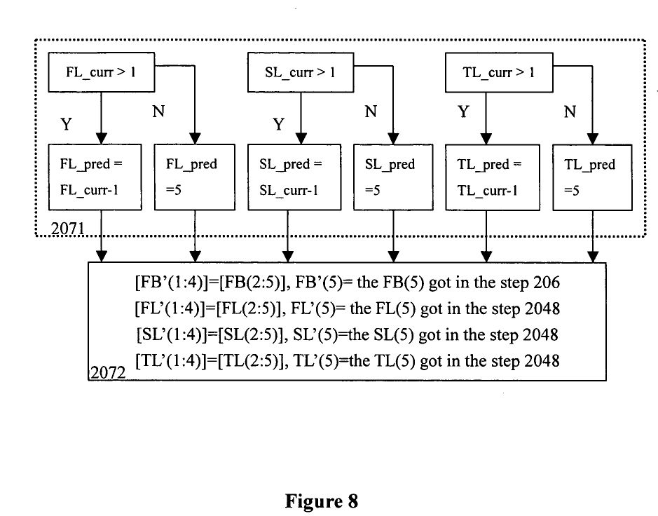

Step 207: Data update. Please refer to FIG. 8, as the following procedures:

Step 2071: The current sequence is 5, 4, 3, 2, 1, 5, 4, 3, 2, 1, . . . , and the predict sequence is 4, 3, 2, 1, 5, 4, 3, 2, 1, 5, . . . , so this step detects the current values of each layer. If the value is bigger than 1 (i.e. 2˜5), the predicted value is the current value subtract 1 (i.e. 1˜4). If the current value is 1, the predicted value is 5.

Step 2072: The current sequence is 5, 4, 3, 2, 1, 5, 4, 3, 2, 1, . . . , and the predict sequence is 4, 3, 2, 1, 5, 4, 3, 2, 1, 5, . . . . Because the minimum is found by 5 digits of a window range, it is necessary to shift left a digit. The new FB′(5) is obtained from the FB(5) by step 206; new FL′(5), SL′(5) and TL′(5) are obtained from FL(5), SL(5) and TL(5) by step 2048.

Step 208: Result sequence. Check if the 5 bits in the flag bit matrix are all 1. If true, it is film mode source, and the flag=1; otherwise, it isn't film mode source, and the flag=0.

Step 201: Choose a proper de-interlaced method by the result of the detected source mode. If it is Interlaced video source mode, choose a proper de-interlacing algorithm. Otherwise, if it is the film mode source, choose a proper weave method. Please refer to FIG. 6, the procedures is as follows:

Step 2011: Check if it is a film mode source. If Flag=0, it is not a film mode source, that is, it is the Interlaced video source mode. It is necessary to go to step 2012 to use a proper de-interlacing algorithm. Otherwise, if flag=1, the film mode source is detected, and the best de-interlacing method is weaving method to preserve the vertical resolution, but we still have to decide the correct sequences for weaving, so continue to next step.

Step 2012: The source mode is Interlaced video, so we need a proper de-interlacing algorithms. We can choose 3D Motion Adaptive De-interlacing Algorithm or Motion-compensated Algorithm, etc.

Step 2013: This step is used to check the value of SL_pred, so that proper-candidates can be chosen. If SL_pred equal to 5, 4 or 2, go to step 2014. Otherwise, go to step 2015.

Step 2014: Choose the weave candidates to be the current field(F1) and the before field(F0) for de-interlacing.

Step 2015: Choose the weave candidates to be the current field(F1) and the next field(F2) for de-interlacing.

The present invention is propsed to improve the conventional technology of field mode source detection. The feature of the present invention is to use counters to judge instead of absolute values, and to induct the idea of layer. Each layer has its own threshold to expand its robustness. Furthermore, we use the sequence characteristic as the judgement criterion so that the present invention is applicable to every varieties of the detecting of the film mode sources. The improvement of the present invention is to get the result of plural layers (3 layers is used in the present invention) to prevent mistake and avoid the abnormal sequence so that we can determine quickly and correctly. If we want to detect varieties of abnormal sequences, we still can use more layers (take 4 layers for examples) to meet the objective.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for robust layered 3:2 pulldown film mode source detection, said method providing video signals of three fields, a current field, a last field and a next field, said video signals being used to determine a film source and said method comprising steps of:
defining a plurality of layers and each layer has a threshold and a counter;
comparing each difference between pixels of said last field and said next field with each layer's threshold to obtain a comparing result;
according to said comparing result, determining a change of said counter of every layer; and
determining a result sequence by said counter to decide said film mode source.

2. The method according to claim 1 wherein said layers are three.

3. The method according to claim 1 wherein said counter of a layer is increased by 1 when the absolute value of each difference is bigger than a threshold of a layer.

4. The method according to claim 1 wherein said result sequence uses the fame difference of the film source processed by 3:2 pulldown as the fixed sequence by its counter.
